(19) United States
(12) Patent Application Publication
(10) Pub. No.: US 2012/0056403 A1
(43) Pub. Date: Mar. 8, 2012

(54) MOTORCYCLE WITH AUTO UP AND DOWN AUXILIARY WHEEL STAND

(76) Inventor: San-Lang LIAN, Hualien City (TW)

(21) Appl. No.: 13/005,927

(22) Filed: Jan. 13, 2011

(30) Foreign Application Priority Data
Sep. 6, 2010 (TW) 099129987
Oct. 4, 2010 (TW) 099133692

(51) Int. Cl. B62H 1/06

(52) U.S. Cl. 280/304

(57) ABSTRACT

A motorcycle includes a motorcycle body, two extendable units, a speed sensor, and two auxiliary wheel stands. The speed sensor detects the speed of the motorcycle body. Each auxiliary wheel stand includes a stand body and an auxiliary wheel body. One end of the stand body is pivotally connected to the motorcycle body, and the auxiliary wheel body is disposed on the other end of the stand body. One end of each extendable unit is fixed to the motorcycle body, and the other end thereof is connected to the stand body. When the speed of the motorcycle body is slower than a threshold value, the extendable units elongate and push the stand bodies, thereby descending the auxiliary wheel bodies to the ground.

### CROSS REFERENCE TO RELATED APPLICATIONS

This Non-provisional application claims priority under 35 U.S.C. §119(a) on Patent Application No(s). 099129987 and 099133692 filed in Taiwan, Republic of China on Sep. 6, 2010, and Oct. 4, 2010, the entire contents of which are hereby incorporated by reference.

### BACKGROUND OF THE INVENTION

1. Field of Invention

The present invention relates to a motorcycle and, in particular, to a motorcycle with a stand.

2. Related Art

Compared with cars, motorcycles or scooters are smaller and cheaper, and they can easily pass through the traffic areas and be easily parked. Thus, the motorcycle or scooter has many advantages especially in the down town areas.

FIG. 1 is a schematic diagram showing a conventional motorcycle 1. As shown in FIG. 1, the motorcycle 1 includes a handle mechanism 11, a front wheel 12, a seat 13, an engine unit 14, a main stand 15, a shield 16, and a rear wheel 17.

The handle mechanism 11 includes a handle 111 connecting to the front wheel 12, so that the rider can use the handle 111 to control the direction of the motorcycle 1. The rider can sit on the seat 13. The engine unit 14 is usually configured underneath the seat 13. The rear end of the engine unit 14 is pivotally connected with the rear wheel 17 so as to drive the rear wheel 17 to rotate. Then, the rolling rear wheel 17 can simultaneously carry the front wheel 12 to rotate, so that the motorcycle 1 moves forwardly. Accordingly, the rider can successfully control the motorcycle 1 with its handle mechanism 11. In addition, the main stand 15 is configured between the front wheel 12 and the rear wheel 17, and it is used for supporting the motorcycle 1 when parking. Most of other components are installed inside the shield 16, and the shield 16 may have various appearance designs. Moreover, the motorcycle 1 may further include a minor side stand 18, which is configured at one side of the motorcycle 1. Thus, when the rider parks the motorcycle 1 with the side stand 18, the motorcycle body is inclined.

The main stand 15 has two support points for contacting with the ground. In the prior art, when the rider parks the motorcycle 1 with the main stand 15, he/she usually holds the handle mechanism 11 with his/her hands, steps against the main stand 15 with one foot, and then pulls the motorcycle 1 backwardly and slight upwardly. Accordingly, the main stand 15 can stand well on the ground. At this moment, the rear wheel 17 usually leaves the ground, and only the front wheel 12 and the two support points of the main stand 15 can contact with the ground, which is enough to support the entire motorcycle 1. After that, even though the rider looses his/her hands from the motorcycle 1, the motorcycle 1 can still stand firmly.

However, to park the motorcycle 1 with the main stand 15 needs the rider to use both hands and foot and to apply a certain force to pull the motorcycle 1. This may be inconvenient for some riders such as elder, weak and handicapped people. Therefore, it is an important subject to provide a motorcycle that is equipped with convenient parking function.

### SUMMARY OF THE INVENTION

In view of the foregoing subject, an objective of the present invention is to provide a motorcycle with auto up and down auxiliary wheel stand.

To achieve the above objective, the present invention discloses a motorcycle including a motorcycle body, two extendable units, a speed sensor, and two auxiliary wheel stands. The speed sensor detects the speed of the motorcycle body and is electrically connected to the extendable units. Each auxiliary wheel stand includes a stand body and an auxiliary wheel body. One end of the stand body is pivotally connected to the motorcycle body, and the auxiliary wheel body is disposed on the other end of the stand body. Each extendable unit has one end fixed to the motorcycle body and the other end connected to the stand body. When the speed of the motorcycle body is slower than a first threshold value, the extendable units elongate and push the stand bodies, thereby descending the auxiliary wheel bodies to the ground.

In one embodiment of the present invention, the extendable unit includes a pneumatic actuator, a hydraulic actuator, or a hydraulic/pneumatic actuator.

In one embodiment of the present invention, the motorcycle body includes a gas storage bottle or an oil storage tank connecting with the extendable unit.

In one embodiment of the present invention, the auxiliary wheel body includes a caster.

In one embodiment of the present invention, each extendable unit includes a pressure relief valve. When the speed of the motorcycle body is faster than a second threshold value, the pressure relief valves are enabled to release pressure. Accordingly, the extendable units are compressed to pull the stand bodies, thereby rising the auxiliary wheel to a standby position.

In one embodiment of the present invention, the motorcycle further includes a balance unit, which includes a mass body and a pipe. The mass body is pivotally disposed on the pipe. Each of two ends of the pipe has a gate, and the two ends of the pipe are connected to the extendable units respectively.

In one embodiment of the present invention, when the motorcycle body is inclined to one side, the mass body moves by gravity to open the gate at this side, so that the extendable unit at this side elongates.

In one embodiment of the present invention, the motorcycle body further includes a weight sensor for detecting a weight carried by the motorcycle body and transmitting a signal to the extending unit according to the detecting result.

In one embodiment of the present invention, the pressure inside the extending unit is changed according to the signal from the weight sensor.

As mentioned above, the motorcycle of the present invention is configured with the extendable unit and the auxiliary wheel stands for replacing the convention main stand. When the speed of the motorcycle body is slower than a first threshold value, the extendable units elongate and push the stand bodies, thereby descending the auxiliary wheel bodies to the ground. Since the auxiliary wheel stands can provide the desired supporting forces at two sides of the motorcycle body, the motorcycle can be automatically and stably parked when it is slowed down or stopped. In the invention, the rider does not have to additionally apply the force to the conventional main stand for parking the motorcycle. This can automatically achieve the balance of the motorcycle and finish the parking operation thereof, so that the present invention can prevent the accident that the rider may lose balance and fall down during slow riding and stopping. Besides, when the speed of the motorcycle body is faster than a second threshold value, the extendable units are automatically compressed to pull the stand bodies, thereby rising the auxiliary wheel bodies.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional motorcycle;

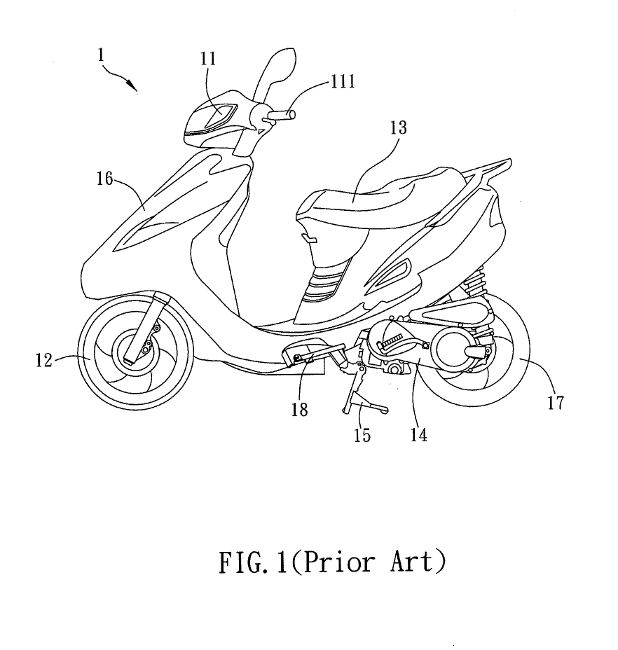

FIG. 2 is a side view of a motorcycle according to a preferred embodiment of the present invention;

FIG. 3 is a schematic diagram showing the extendable unit and the auxiliary wheel stand of the motorcycle according to the preferred embodiment of the present invention; and

FIG. 4 is a schematic diagram showing the balance unit of the motorcycle according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

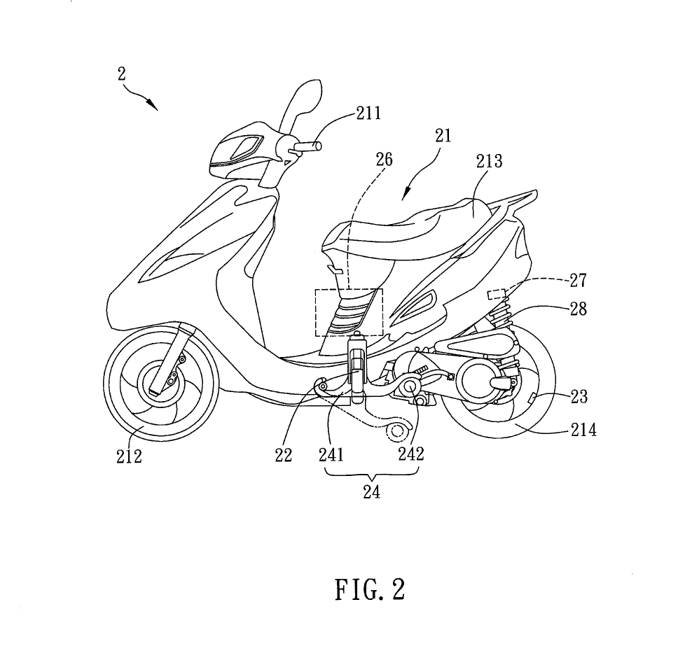

FIG. 2 is a side view of a motorcycle 2 according to a preferred embodiment of the present invention. As shown in FIG. 2, the motorcycle 2 includes a motorcycle body 21, two extendable units 22, a speed sensor 23, and two auxiliary wheel stands 24.

The motorcycle body 21 can be any kind of the conventional motorcycle body, which does not include the conventional main stand. In this embodiment, the motorcycle body 21 mainly includes a handle mechanism 211, a front wheel 212, a seat 213, an engine unit (not shown), and a rear wheel 214.

The handle mechanism 211 includes a handle connecting with the front wheel 212, so that the rider can hold the handle to control the direction of the motorcycle 2. The rider sits on the seat 213, and the engine unit is configured underneath the seat 213. The rear end of the engine unit is pivotally connected with the rear wheel 214 so as to drive the rear wheel 214 to rotate. Then, the rolling rear wheel 214 can simultaneously carry the front wheel 212 to rotate, so that the motorcycle 2 moves forwardly. Accordingly, the rider can successfully control the motorcycle 2 through its handle mechanism 211.

One end of each extendable unit 22 is fixed to the motorcycle body 21. Please be noted that FIG. 2 only shows one of the extendable units 22. In this embodiment, the extendable unit 22 is disposed between the front wheel 212 and the rear wheel 214 of the motorcycle body 21, and it is not located on the connecting line of the front wheel 212 and the rear wheel 214. In practice, the extendable units 22 are located at two sides of the motorcycle body 21 respectively, so that they can be used as two supporting points of the motorcycle body 21.

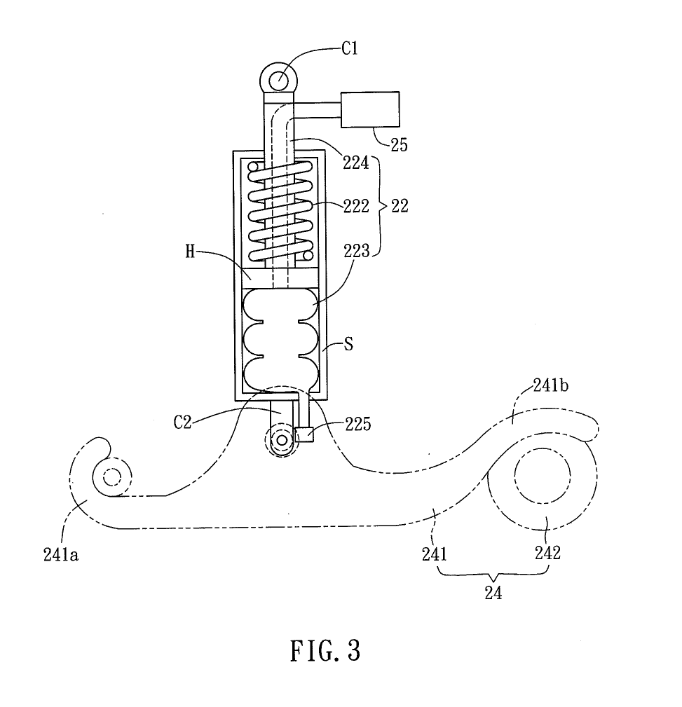

FIG. 3 is a schematic diagram showing the extendable unit and the auxiliary wheel stand of the motorcycle according to the preferred embodiment of the present invention. With reference to FIGS. 2 and 3, one end C1 of the extendable unit 22 is fixed to the motorcycle body 21. In this embodiment, the end C1 of the extendable unit 22 is fixed to a certain portion on the shield of the motorcycle body 21, which is located near the seat 213. The mechanism of the extendable unit 22 is driven by a pneumatic, hydraulic, or hydraulic/pneumatic power source. For example, the extendable unit 22 may include a pneumatic actuator, a hydraulic actuator, or a hydraulic/pneumatic actuator. In this embodiment, the power source of the extendable unit 22 is a pneumatic actuator. In more detailed, the motorcycle 2 includes a gas storage bottle 25 connected with the extendable unit 22. To be noted, if the power source of the extendable unit 22 is a hydraulic actuator, the gas storage bottle 25 can be replaced by an oil storage tank with compression equipment. In the current embodiment, the extendable unit 22 includes a spring 222, a gas-charged bag 223, a piston 224, and a pressure relief valve 225. The spring 222, the gas-charged bag 223, and a part of the piston 224 are disposed inside a shield S. The spring 222 is telescoped on the piston 224. One end of the spring 222 contacts against the shield S, and the other end thereof contacts against the head H of the piston 224. The gas-charged bag 223 contacts against the other end of the head H of the piston 224. In this case, the charging level of the gas-charged bag 223 can correspondingly move the position of the piston 224, thereby controlling the extending length of the extendable unit 22.

The speed sensor 23 can detect the speed of the motorcycle body 21 and is electrically connected with the extendable unit 22. In this embodiment, the speed sensor 23 is disposed on the wheel rim of the rear wheel 214 of the motorcycle body 21 for example. The extendable unit 22 may further include a controller for receiving the signal from the speed sensor 23, and the controller can determine whether to supply the compressed gas to charge the gas-charged bag 223.

The auxiliary wheel stand 24 includes a stand body 241 and an auxiliary wheel body 242. One end 241a of the stand body 241 is pivotally connected to a portion of the motorcycle body 21, which is near the step mat or the accommodating space of the motorcycle body 21 for example. The auxiliary wheel body 242 is disposed on the other end 241b of the stand body 241. Because the end C1 (upper end) of each extendable unit 22 is fixed to the motorcycle body 21, and the other end C2 (bottom end) thereof contacts against and is pivotally connected to the stand body 241, the extendable units 22 can elongate and push the stand bodies 241, thereby descending the auxiliary wheel bodies 242 to the ground (shown as the dotted lines in FIG. 2). Herein, the auxiliary wheel body 242 may include a caster, which can rotate in any angle so as to slide in the progressing direction. The diameter of the auxiliary wheel body 242 may smaller than that of the front or rear wheel and, moreover, smaller than a half of that of the front or rear wheel.

When the motorcycle body 21 moves in low speed or is slowed down for preparing the parking procedure, the speed sensor 23 can detect that the speed thereof is slower than a first threshold value, which can be set by the user, and then control to supply the compressed gas from the gas storage bottle 25 to automatically charge the gas-charged bag 223. Accordingly, the gas-charged bag 223 can be expanded so as to push the piston 224 upwardly to compress the spring 222. Since the upper end C1 of the extendable unit 22 is fixed to the motorcycle body 21, the extendable unit 22 can automatically elongate downwardly to push the stand body 241, thereby descending the auxiliary wheel body 242 to the ground. Consequently, the auxiliary wheel bodies 242 located at two sides of the motorcycle body 21 can cooperate with the front or rear wheel to support the motorcycle body 21. On the contrary, when the motorcycle 2 starts to progress and the speed of the motorcycle body 21 is faster than a second threshold value, the pressure relief valve 225 disposed on the gas-charged bag 223 can be automatically enabled to release gas therein. In this case, the contained gas in the gas-charged bag 223 is reduced, and restoring force of the spring 222 can press the head H of the piston 224 downwardly. Consequently, the extending units 22 can automatically compressed to pull the stand bodies 241, thereby rising the auxiliary wheel bodies 242. In the current embodiment, when the speed of the motorcycle body 21 is faster than 10 km/hr, the auxiliary wheel bodies 242 are raised. Therefore, when the motorcycle 2 is running in high-speed, the auxiliary wheel bodies 242 can not contact with the ground. This can reduce the friction force and prevent the damage of the auxiliary wheel bodies 242. As mentioned above, the auxiliary wheel stands 24 are disposed at two end of the motorcycle body 21 for supporting it, so that the rider does not have to additionally apply the force to the conventional main stand for parking when the motorcycle 2 is in low riding or is stopped. This can automatically achieve the balance of the motorcycle 2 and finish the parking operation thereof, so that the present invention can prevent the accident that the rider may lose balance and fall down during slow riding and stopping.

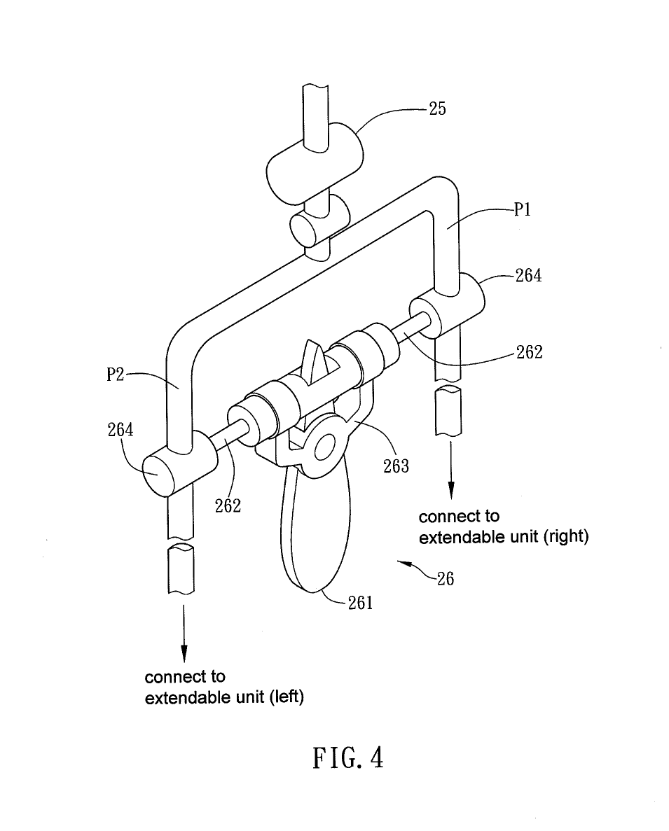

FIG. 4 is a schematic diagram showing the balance unit of the motorcycle according to the preferred embodiment of the present invention. Referring to FIGS. 2 and 4, the motorcycle 2 may further include a balance unit 26. This configuration is to protect the rider from falling down when the motorcycle 2 is running in slow speed on a non-planar road. The balance unit 26 includes a mass body 261, a pipe 262 and a pivoting element 263. The mass body 261 can be a plumb or a counterweight with a certain weight, which can be made of metal or alloy. The mass body 261 is pivotally disposed on the pipe 262, and it can swing according to the inclines of the motorcycle body 21. Each of two ends of the pipe 262 has a gate 264, and the two ends of the pipe 262 are connected to the extendable units 22. In other words, the two ends of the pipe 262 are connected to the inlet pipes P1 and P2 of the gas storage bottle 25 through the gates 264. The inlet pipes P1 and P2 are connected to the gas-charged bags 223 of the extendable units 22. The valves 264 at two ends of the pipe 262 can be opened or closed according to the swing of the mass body 261 so as to control the compressed gas to enter the extendable units 22. For example, when the motorcycle 2 inclines towards one side, the mass body 261 also inclines to this side due to the gravity. Accordingly, the valve 264 at this side can be opened (e.g. if the motorcycle 2 inclines towards the left side, the valve 264 at left side is opened). Then, the gas can flow into the extendable unit 22 at this side, so that this extendable unit 22 can elongate to descend the auxiliary wheel body 242 of this side. This can help the motorcycle 2 to keep its balance so as to prevent the undesired accident. In addition, it is also possible to facilitate the motorcycle 2 to run on a non-planar road by descending the auxiliary wheel stands 24 of two sides at different altitudes.

Referring to FIG. 2 again, the motorcycle 2 further includes a weight sensor 27 disposed on the rear wheel cushion 28. Because different riders have different body weights, the motorcycle body 21 burdening different riders may have different altitudes. In this case, the weight sensor 27 can detect a weight carried by the motorcycle body 21 and transmitting a feedback signal to the extending units 22 according to the detecting result. Then, the extendable unit 22 can change the pressure inside the gas-charged bag 223 according to the feedback signal from the weight sensor 27, thereby adjusting the descending position of the auxiliary wheel stand 24. In addition, if an abnormal weight is applied onto the motorcycle body 21, the pressure relief valve 225 of the extendable unit 22 can automatically release the redundant gas so as to decrease the descended distance of the auxiliary wheel stand 24.

As mentioned above, the motorcycle of the present invention is configured with the extendable unit and the auxiliary wheel stands for replacing the convention main stand. When the speed of the motorcycle body is slower than a first threshold value, the extendable units can automatically elongate to push the stand bodies, thereby descending the auxiliary wheel bodies to the ground. Since the auxiliary wheel stands can provide the desired supporting forces at two sides of the motorcycle body, the motorcycle can be automatically and stably parked when it is slowed down or stopped. In the invention, the rider does not have to additionally apply the force to the conventional main stand for parking the motorcycle. This can automatically achieve the balance of the motorcycle and finish the parking operation thereof, so that the present invention can prevent the accident that the rider may lose balance and fall down during slow riding and stopping. Besides, when the speed of the motorcycle body is faster than a second threshold value, the extendable units are automatically compressed to pull the stand bodies, thereby rising the auxiliary wheel bodies.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motorcycle comprising:
a motorcycle body;
two extendable units, each of which has one end fixed to the motorcycle body;
a speed sensor, which detects the speed of the motorcycle body and is electrically connected to the extendable units; and
two auxiliary wheel stands, each of which includes a stand body and an auxiliary wheel body, wherein one end of the stand body is pivotally connected to the motorcycle body, the auxiliary wheel body is disposed on the other end of the stand body, and the other end of the extendable unit is connected to the stand body;
wherein, when the speed of the motorcycle body is slower than a first threshold value, the extendable units elongate and push the stand bodies, thereby descending the auxiliary wheel bodies to the ground.

2. The motorcycle according to claim 1, wherein the extendable unit comprises a pneumatic actuator, a hydraulic actuator, or a hydraulic/pneumatic actuator.

3. The motorcycle according to claim 1, wherein the motorcycle body comprises a gas storage bottle or an oil storage tank connecting with the extendable unit.

4. The motorcycle according to claim 1, wherein the auxiliary wheel body comprises a caster.

5. The motorcycle according to claim 1, wherein each of the extendable units comprises a pressure relief valve, and when the speed of the motorcycle body is faster than a second threshold value, the pressure relief valves are enabled to release pressure so that the extendable units are compressed to pull the stand bodies, thereby rising the auxiliary wheel to a standby position.

6. The motorcycle according to claim 1, further comprising:
a balance unit comprising a mass body and a pipe, wherein the mass body is pivotally disposed on the pipe, each of two ends of the pipe has a gate, and the two ends of the pipe are connected to the extendable units.

7. The motorcycle according to claim 6, wherein when the motorcycle body is inclined to one side, the mass body moves by gravity to open the gate at the side, so that the extendable unit at the side elongates.

8. The motorcycle according to claim 1, wherein the motorcycle body further comprises a weight sensor for detecting a weight carried by the motorcycle body and transmitting a signal to the extending unit according to the detecting result.

9. The motorcycle according to claim 8, wherein the pressure inside the extending unit is changed according to the signal from the weight sensor.
